(19) United States
(12) Patent Application Publication
(10) Pub. No.: US 2014/0295393 A1
(43) Pub. Date: Oct. 2, 2014

(54) INTERACTIVE REHABILITATION METHOD AND SYSTEM FOR MOVEMENT OF UPPER AND LOWER EXTREMITIES

(71) Applicant: Industrial Technology Research Institute, Hsinchu (TW)

(72) Inventors: SHIH YING CHIEN, KEELUNG CITY (TW); YIO WHA SHAU, TAIPEI CITY (TW)

(21) Appl. No.: 14/308,675

(22) Filed: Jun. 18, 2014

Related U.S. Application Data
(62) Division of application No. 12/189,068, filed on Aug. 8, 2008.

(30) Foreign Application Priority Data
Aug. 10, 2007 (TW) 96129617

(51) Int. Cl. G06F 19/00

(52) U.S. Cl. CPC G06F 19/3481
USPC 434/257

(57) ABSTRACT

An interactive rehabilitation method for movement of upper and lower extremities is disclosed. An identification label of an extracted image is detected to provide an operating position of an image of an extremity. A movement mode for a target image is determined according to the identification label and the target image is displayed in a scene. It is determined whether identification labels corresponding to movement of an extremity of the target image are being continuously obtained, and, if so, the performance of the movement of the extremity is led based on operational guidance. A feedback operation is provided according to the movement of the extremity, preset movement paths and velocities, and targeted positions of the target image. It is determined whether the target image has been moved to the preset targeted positions, and, if so, the performance of the movement of the extremity is graded.

### CROSS REFERENCE TO RELATED APPLICATIONS

This application is a divisional of U.S. patent application Ser. No. 12/189,068 filed 8 Aug. 2008 which claims priority of Taiwan Patent Application No. 96129617, filed on 10 Aug. 2007, the disclosure of which is hereby incorporated by reference herein in its entirety.

### TECHNICAL FIELD

The technical field relates to interactive rehabilitation, and in particular to interactive rehabilitation systems and methods.

### BACKGROUND

Given the aging society, it has become more apparent that many everyday care products for older persons, do not meet or fully satisfy the needs of older persons. This is especially noticeable when looking at medical treatment for extremity and extremity attachments for apoplexy victims, wherein, the demand to provide more enjoyable and interesting extremity rehabilitation is growing. Note that it is assumed that current extremity rehabilitation for older persons are extremely boring, and because of this in part, causes poor rehabilitation results.

One solution for the aforementioned problem, is to provide interactive games comprising virtual computer images for apoplexy victims, which are not only enjoyable but also provide extremity rehabilitation for the apoplexy victims. Thus, assisting to improve rehabilitation results of apoplexy victims.

Thus, an interactive rehabilitation method and system for upper and lower extremities is desirable, assisting with extremity rehabilitation and body training (Chinese shadow boxing, for example) for apoplexy victims via virtual computer images of interactive games.

### SUMMARY

Interactive rehabilitation methods are provided. An exemplary embodiment of an interactive rehabilitation method comprises the following. An identification label of an extracted image is detected to provide an operating position of an image of an extremity. A movement mode for a target image is determined according to the identification label and the target image is displayed in a scene. It is determined whether identification labels corresponding to movement of an extremity of the target image are being continuously obtained, and, if so, the performance of the movement of the extremity is led based on operational guidance. A feedback operation is provided according to the movement of the extremity, preset movement paths and velocities and targeted positions of the target image. It is determined whether the target image has been moved to the preset targeted positions, and, if so, the performance of the movement of the extremity is graded.

Interactive rehabilitation systems are provided. An exemplary embodiment of an interactive rehabilitation system comprises a hand position monitoring module, a target image movement control module, an image feedback module, and a movement evaluation module. The hand position monitoring module detects an identification label of an extracted image to provide an operating position of an image of an extremity. The target image movement control module determines a movement mode for a target image according to the identification label, displays the target image in a scene, determines whether identification labels corresponding to movement of an extremity of the target image are being continuously obtained, and, if the identification labels are being continuously obtained, leading the movement of the extremity based on operational guidance. The image feedback module provides a feedback operation according to the movement of the extremity, preset movement paths and velocities and targeted positions of the target image. The movement evaluation module grades the movement of the extremity when the target image has been moved to the preset targeted positions.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIG. 1 is a schematic view of a computer system of the present invention;

FIG. 2 is a schematic view of an interactive rehabilitation system 100 shown in FIG. 1 of the present invention;

FIG. 3 is a flowchart of an interactive rehabilitation method of the present invention;

FIG. 4 illustrates human extremities;

FIG. 5 illustrates a behavioral range of the operator detected by an image extraction device;

FIG. 6 illustrates grabbing a sphere in a game scene;

FIG. 7 illustrates feedback states in response to operator movements in the game scene; and

FIGS. 8-11 illustrate Chinese shadow boxing motions.

### DETAILED DESCRIPTION

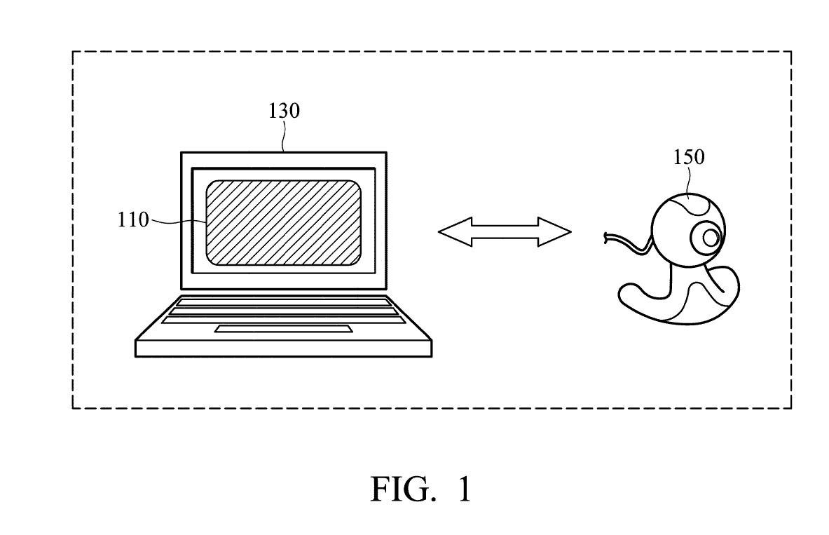

Several exemplary embodiments of the invention are described with reference to FIGS. 1 through 3, which generally relate to interactive rehabilitation for movement of upper and lower extremities. It is to be understood that the following disclosure provides various different embodiments as examples for implementing different features of the invention. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

The invention discloses an interactive rehabilitation method and system for mobility of upper and lower extremities, assisting extremity rehabilitation and body training (Chinese shadow boxing, for example) for apoplexy patients via virtual computer images of interactive games.

Given the aging society, the invention provides an interactive game for older persons to play the game indoors, and provide brain stimulus and entertainment to facilitate independence of older persons. Additionally, the video system of the game enables older persons to play with and interact with their children or other players, which assists in social interaction, thus, slowing the aging process in mind and soul.

An embodiment of an interactive rehabilitation method and system for extremities can serve as training equipment for interactive extremity rehabilitation, immediately leading operators to perform extremity rehabilitation or training exercise via the game.

FIG. 1 is a schematic view of a computer system of the present invention.

An embodiment of an interactive extremity rehabilitation system 110 is implemented in a computer device 130. The computer device 130 is wired or wireless-connected to an image extraction device (a Webcam, for example) 150. The image extraction device 150 can be internally installed in the computer device 130. The interactive extremity rehabilitation system 110 extracts real-time images of a person via the image extraction device 150 and transmits the extracted images to the computer device 130 to be displayed in a user interface (not shown) provided by the interactive extremity rehabilitation system 110. Additionally, the image extraction device 150 comprises an image identification system program for analyzing an image scope of a reaction area, retrieving movements from the start to the end of extremities, and performing real-time operations for dynamic images and returning feedbacks for flexibility training of extremities.

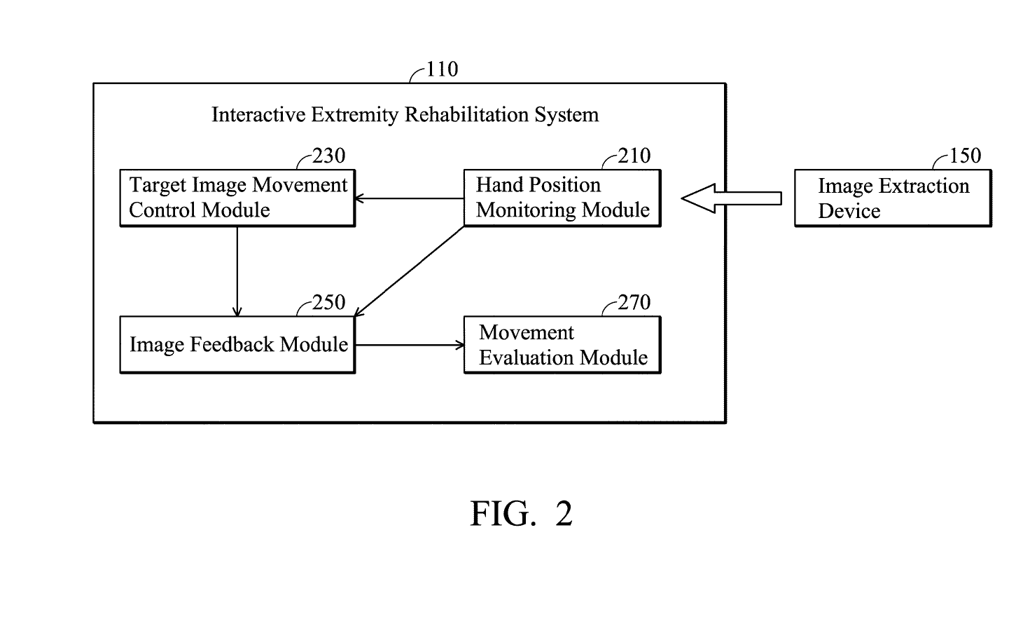

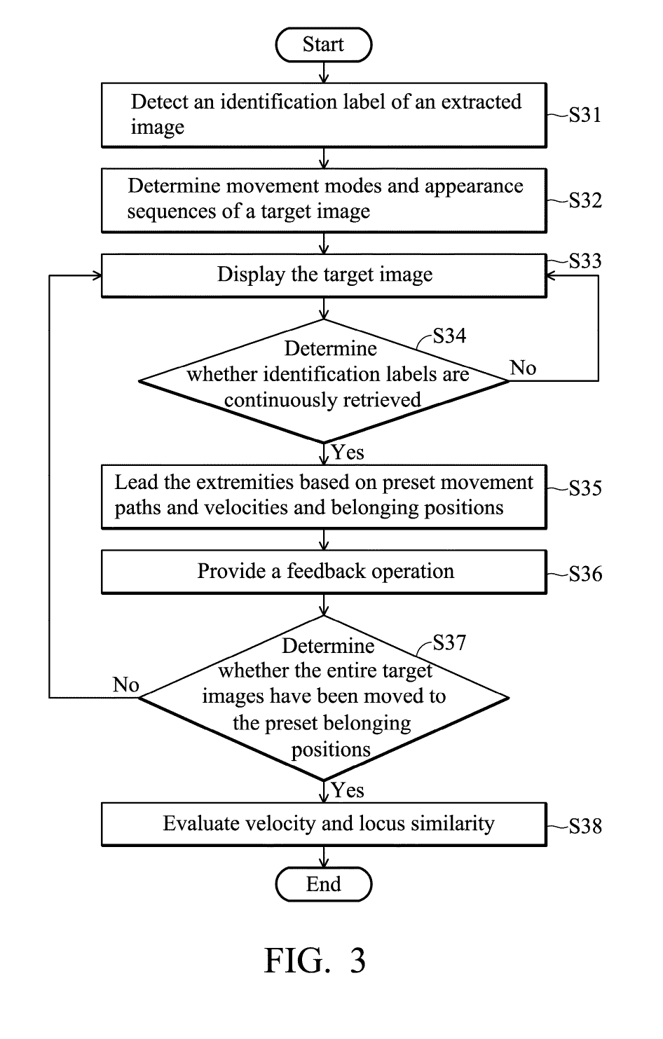

FIG. 2 is a schematic view of an interactive extremity rehabilitation system 110 shown in FIG. 1 of the present invention. FIG. 3 is a flowchart of an interactive rehabilitation method of the present invention.

The exemplary embodiment of an interactive rehabilitation system 110 comprises a hand position monitoring module 210, a target image movement control module 230, an image feedback module 250, and a movement evaluation module 270. A process for the exemplary embodiment of the interactive rehabilitation system 110 is first described in the following.

Referring to FIGS. 1-3, a color mark or recognizable mark (defined as an identification label in this embodiment) for a position is first placed on a detected portion of an operator for extraction by the image extraction device 150 before the rehabilitation process starts. When a game provided by the present invention is activated, the interactive rehabilitation system 110 detects extremity movements (hand movements, for example) of the operator using the image extraction device 150. The hand position monitoring module 210 detects the identification label of an extracted image of the operator extracted by the image extraction device 150 to provide a corresponding position (defined as an extremity position) for extremities in a game scene (step S31).

The target image movement control module 230 retrieves the identification label corresponding to the movement of the extremities from the hand position monitoring module 210 to determine movement modes and appearance sequences of a target image (step S32). The system predefines required target images and classifications (Chinese shadow boxing motions or sphere grabbing actions, for example, which are not to be limitative). Each targets image and classification comprises plural movements and movement paths and velocities, and targeted positions are preset to movements of each target image. The preset data is stored in a database (not shown). Extremity movements of the operator correspond to movements of the target image. When a movement of an extremity corresponding to the identification label is retrieved, the target image movement control module 230 immediately selects a movement mode and an appearance sequence of the target image corresponding to the movement of the extremity and displays the target image (step S33), a Chinese shadow boxing motion or a sphere grabbing action, for example.

The target image movement control module 230 determines whether identification labels corresponding to movement of an extremity of the target image are being continuously retrieved from the hand position monitoring module 210 (step S34), i.e. determining whether the operator performs the Chinese shadow boxing motion or sphere grabbing action. If the identification labels are not continuously retrieved, which indicates that the operator did not completely perform the movement, does not know how to perform the movement, or has forgotten how to perform the movement, the operator is reminded how to perform the movement by arrow guidance or other eye-catching suggestions. If the identification labels are being continuously retrieved, the extremities (the hands, for example) of the operator is led based on the preset movement paths and velocities and the targeted positions via operational guidance (step S35). The operator, for example, is led to grab a target image in a game scene and place the target image at a correct target position or perform a Chinese shadow boxing motion.

The image feedback module 250 provides a feedback operation for the operator according to the movement of the extremity, the preset movement paths and velocities and the targeted positions (step S36). Shapes, emotional expressions and sounds of the target image, for example, are changed or an error message (image) or sound effect is shown. When the hand image (i.e. the movement of the extremity) of the operator overlaps the target image (while grabbing the target image) or velocity or locus difference (fast and slow motions of the Chinese shadow boxing motions) therebetween is generated, the feedback operation is provided. The feedback operation indicates image pattern variation and combinations of sound and power outputs or velocity variation, enabling the operator to experience interactions with the target image.

The target image movement control module 230 determines whether all of the target images have been moved to the preset targeted positions (step S37). That is, when a game for grabbing spheres is performed, whether each sphere is placed at its individual position, or, when a game for Chinese shadow boxing motions is performed, whether all Chinese shadow boxing motions are completed, is determined. If a target image has not been moved to the preset targeted positions, the process proceeds to step S33 to repeat the described operations and enable all of the target images to be moved to their preset targeted positions. When all of the target images have been moved to their preset targeted positions, the movement evaluation module 270 grades the movement of the extremities of the operator according to similarity between the movement of the extremities and the target images (step S38), and then the process terminates.

As described, the interactive extremity rehabilitation system 110 enables patients requiring rehabilitation for hand extremities to implement movement training via game interactions. Additionally, the system can provide competition for more than one user at the same game platform via video conference, achieving enjoyable rehabilitation and required training results.

Processes for components of the interactive extremity rehabilitation system 110 are described as follows.

The hand position monitoring module 210 performs skin color recognition (based on the mark placed on the extremities) using computer vision simulation and tracks dynamic object behaviors according to recognition results. Further, the hand position monitoring module 210 extracts images from real-time images retrieved from the image extraction device 150 according to preset skin color definitions, determines whether each pixel on the extracted image comprises an area identical to that of the preset skin color definitions, marking a center of the area, subtracts a position of the center from that of a center of an actual screen, and transmits a control signal of a resulting distance vector to the target image movement control module 230 for tracking.

With respect to the target image movement control module 230, a computer/computer game system provides target images for different types of games and movements, movement paths and velocities, targeted positions, and parameters are preset to each target image. The movement paths and velocities, targeted positions, and parameters are defined according to medical treatment requirements. The target image movement control module 230 leads, controls, and corrects hand movement of the operator to grab and place the target image to a correct target position, correcting and rehabilitating hand function of patients.

Processes for the target image movement control module 230 are described as follows.

To achieve dragging of a target image (a game object) via gestures, an operational scope for a gesture operating area is first locked and an available skin color is separately highlighted using skin color detection. The dragged gesture represents a dynamic process, the gesture operating area provides dynamic signals of a frame, and an available dynamic signal of the gesture operating area is extracted using a frame differential detection method. Next, a logical operation (AND, for example) is implemented to the skin color area with the dynamic signals of the dragged gesture to generate a skin color differential area (i.e. the area in which the gestures of a frame are performed). The skin color differential area corresponds to coordinate positions in the game space, collisions for the skin color differential area and a movement area of the target image are detected, and collision signals serve as determination for selecting a game object. Additionally, to facilitate the target image change, coordinate positions based on the dragged gesture, and the average center coordinate data of the skin color differential area is corresponded to coordinate positions in the game space to generate target coordinates used for leading the target image to move.

With respect to the image feedback module 250, when the hand image of the operator overlaps (i.e. the grabbing movement) the target image or velocity or locus difference between the hand movement and the target image movement is generated, the image feedback module 250 provides a feedback operation with image pattern variation and combinations of sound and power outputs or velocity variation for the operator based on preset parameters. The image feedback module 250 provides leading, controlling, and correcting the hands of the operator to grab and place the game object to a correct target position according to preset values.

Processes for the image feedback module 250 are described as follows.

Movement paths and velocities of a target image are created and parameters of targeted positions of the target image are defined and the defined data is stored in a database (not shown). Additionally, it is determined whether movement values, generated by operational behavior using artificial intelligence (IA), correspond to system defined standard parameters. When the hand images of the operator overlaps (i.e. the grabbing movement) the target image or movement velocities or loci of the hand image and the target image in the game scene are different from the system predefined values (i.e. the predefined parameters), a feedback operation with image pattern variation and combinations of sound and power outputs or velocity variation is provided for the operator based on preset information stored in the database.

With respect to the movement evaluation module 270, a real-time feedback mode is available to the operator according to the movement paths and velocities and targeted positions, so that the operator can be immediately corrected.

Several examples are described to illustrate the process of the interactive extremity rehabilitation system 110.

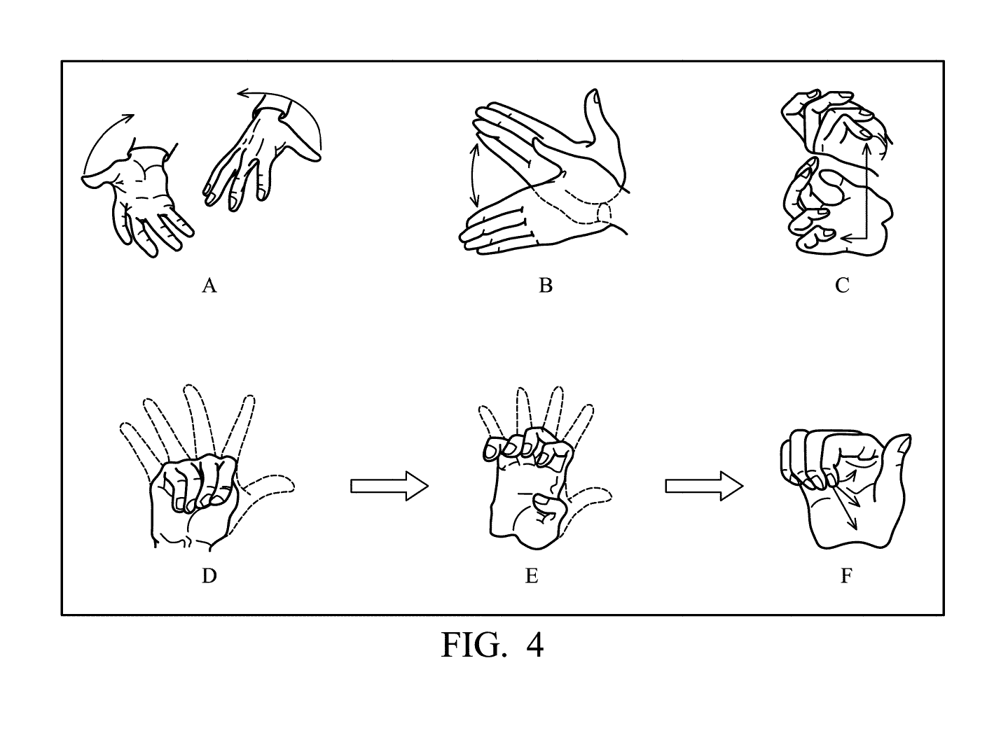

Referring to FIG. 4, human extremities can be at least classified as a wrist swinging around (as shown in Fig. A), a lateral movement (as shown in Fig. B), a finger winding movement (as shown in Fig. C), and clenching movements (as shown in Figs. D˜F). Sphere grabbing motions or Chinese shadow boxing actions can be implemented using the described movements.

For clenching movements, human-machine interactions and image recognition design are applied to achieve accuracy of movement operation and correctness, as the system of the invention provides feedback operations for each movement of the operator. Image pattern variation and combinations of sound and power outputs or velocity variation, for example, enables the operator to experience interaction with the target image. The movement evaluation module 270 determines performance grades according to the interaction between the hand image and the target image.

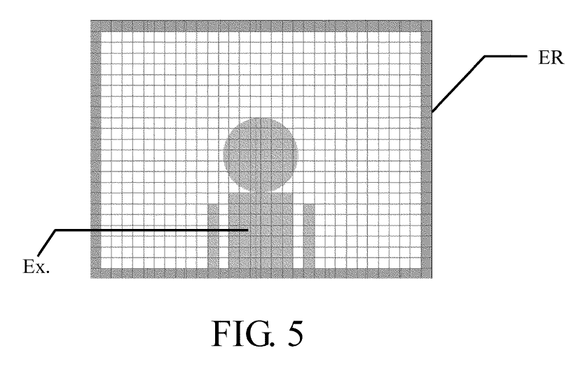

FIG. 5 illustrates a behavioral range of the operator detected by the image extraction device 150. The extractible range (ER) of the image extraction device 150 is shown by the block, wherein the extremities (Ex.) of the operator can only perform inside of the block and will not be detected outside of the block.

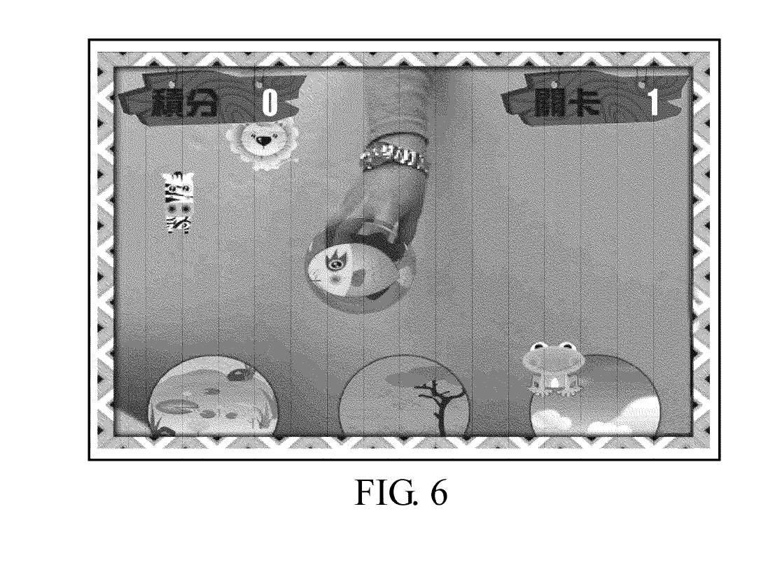

Referring to sphere grabbing in FIG. 6, when the game starts, the system selects and sets an identification label for tracking the operator and displays a target image corresponding to a selected movement mode. The system detects and displays extremities of the operator in a game scene, wherein when the operator grabs a sphere (the target image) in the game scene, the system leads the operator to place the grabbed sphere at a correct target position according to preset targeted positions and parameters stored in a database (not shown), and provides feedback according to velocity or locus similarity of the movement of the extremity. When the current sphere is placed to a correct target position and feedback is provided, the system then displays another sphere in the game scene and leads the operator to place the sphere to a correct target position.

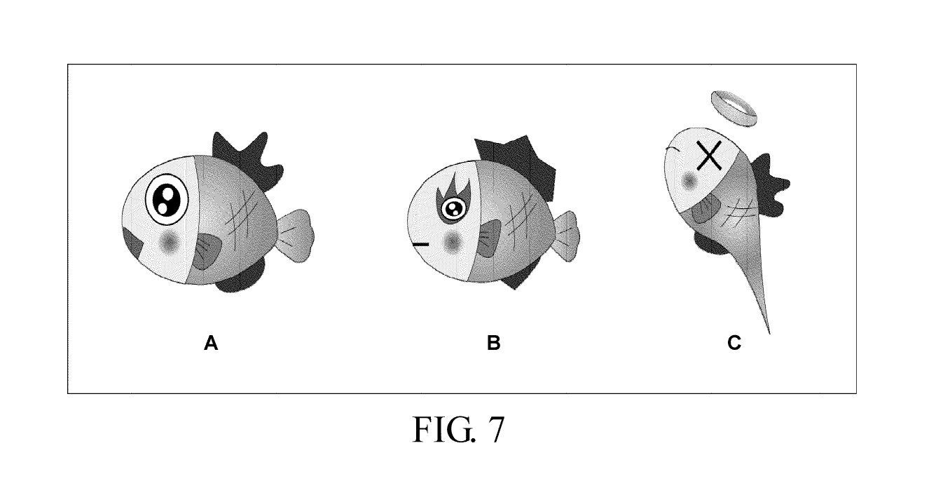

The system leads grabbing movements of the operator according to preset movement paths and velocities for each target image and, when the hand image of the operator overlaps (i.e. the grabbing movement) the target image or velocity or locus difference between the hand movement and the target image movement is generated, leads and corrects movements of the operator based on image movements, emotional expressions, or moving directions. Additionally, the system provides a feedback pattern (located at any position on the sphere or the operating window) to show feedback states in response to operator movements in the game scene. Referring to FIG. 7, Fig. A illustrates a normal state where the sphere has not been grabbed, Fig. B illustrates touching the sphere by the extremity image of the operator, and Fig. C illustrates interactions between the extremity image and the sphere, such that the operator can synchronously experience interactions from the target image during the extremity rehabilitation process.

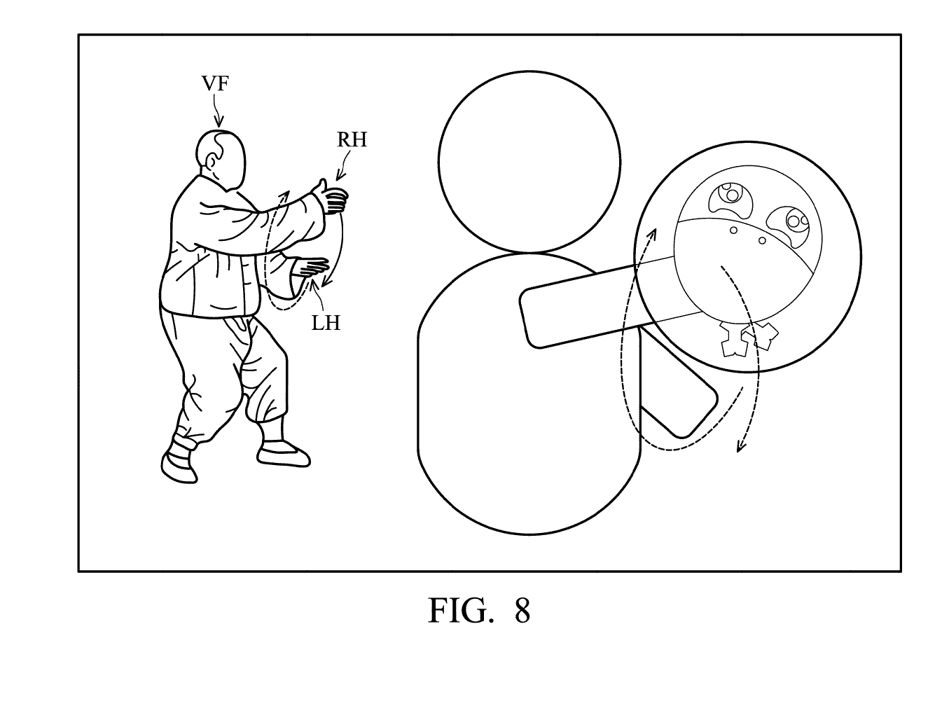

Referring to Chinese shadow boxing motions in FIGS. 8-11, when the game starts, the system selects and sets an identification label for tracking the operator and displays a target image corresponding to a selected movement mode. The system detects and displays extremities of the operator in a game scene, wherein when the operator motions, the system determines movements of the operator as Chinese shadow boxing motions, leads the extremities (both hands in this embodiment) of the operator to move to a correct target position with a correct path using a virtual figure, and provides feedback according to velocity or locus similarity of the movement of the extremities.

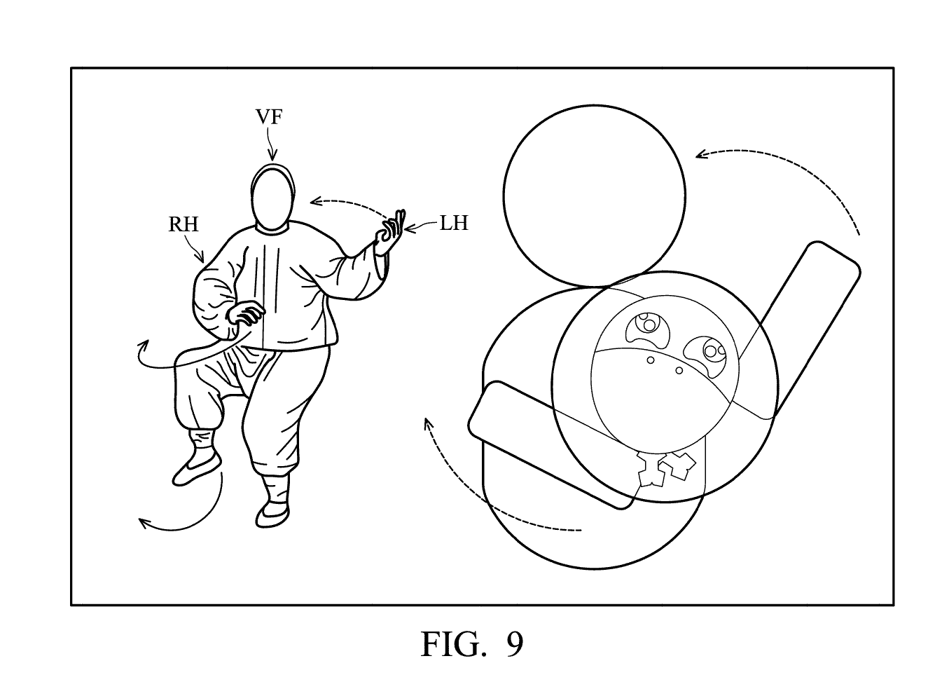

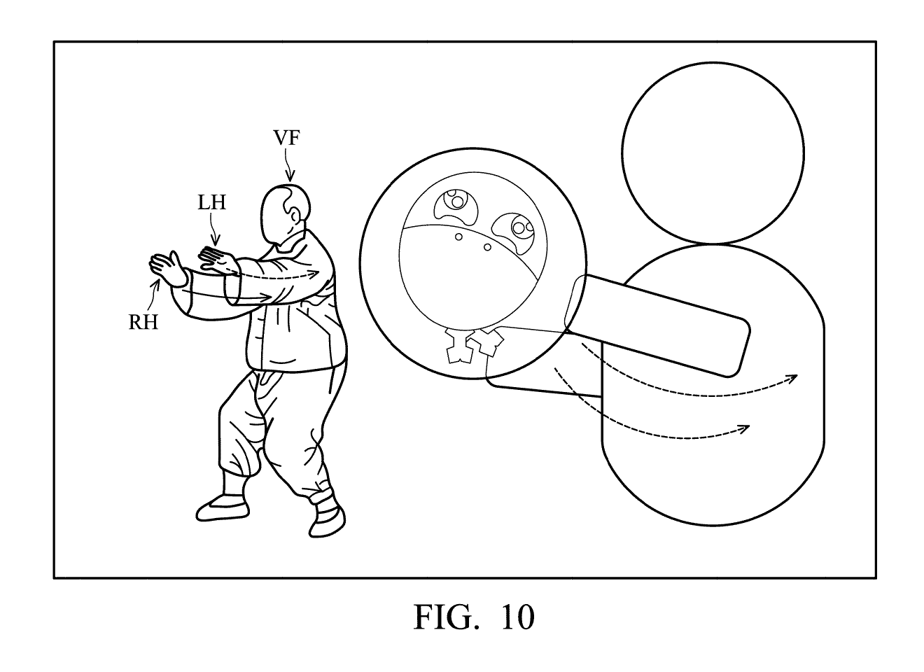

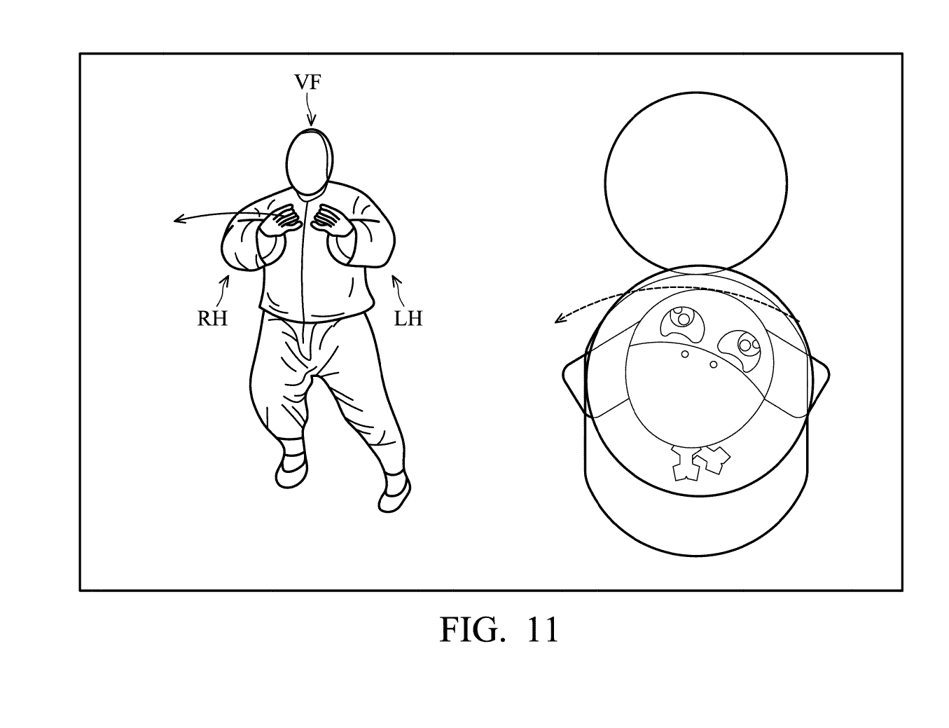

Referring to FIG. 8, the system generates and locates a virtual figure (VF) at the left side of the frame and enables the left hand (LH) and the right hand (RH) of the virtual figure to perform corresponding movements according to preset targeted positions and parameters stored in the database (not shown), facilitating the operator to imitate the movements of the virtual figure. The right side of the frame shows a real figure extracted by an image extraction device. When the operator swings both hands, the real figure in the frame generates corresponding movements. The system determines whether a movement of the operator is correct based on the movement of the real figure and that of the virtual figure and provides feedback (performance grading, for example). When the movement is complete, the system shows another virtual figure of the next Chinese shadow boxing motion (as shown in FIG. 9) and leads the operator to imitate the motion. The described process is repeated to enable the operator to complete the subsequent Chinese shadow boxing motions (as shown in FIGS. 10 and 11) and feedback (performance grades, for example) is provided based on the completed motions, such that the operator can correct his movements according to the feedback.

An embodiment of the interactive rehabilitation method and system promotes flexibility of older persons and improves the extremity ability of the operator via real extremity tanning. Additionally, the invention provides human-machine interactions to improve degeneration of extremity ability for older persons caused by old age via a physical touch platform. The extremity activities for older persons are thus expanded and the game platform allows enjoyable entertainment and recreational activities which improve reaction degeneration of older persons. That is, extremity mobility of patients are improved and influenced unobtrusively and imperceptibly by playing games.

Methods and systems of the present disclosure, or certain aspects or portions of embodiments thereof, may take the form of a program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing embodiments of the disclosure. The methods and apparatus of the present disclosure may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the disclosure. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An interactive rehabilitation method, comprising:
providing path characteristics of a target image;
extracting a movement of an extremity from an extraction device;
enabling the movement of the extremity to interact with the target image in a scene; and
immediately adjusting interaction states between the movement of the extremity and the target image according to the path characteristics.

2. The interactive rehabilitation method as claimed in claim 1, further comprising providing a feedback operation according to the interaction states between the movement of the extremity and the target image.

3. The interactive rehabilitation method as claimed in claim 1, further comprising leading the movement of the extremity based on operational guidance according to preset parameters corresponding to the target image to lead the movement of the extremity to interact with the target image and providing a score according to interactive similarity.
